(19) United States
(12) Patent Application Publication
(10) Pub. No.: US 2013/0304482 A1
(43) Pub. Date: Nov. 14, 2013

(54) Auto-Populated Medication Selection & Ordering System

(71) Applicant: Salman Siddiqui, Newark, DE (US)

(72) Inventor: Salman Siddiqui, Newark, DE (US)

(73) Assignee: SIEMENS MEDICAL SOLUTIONS USA, INC., Malvern, PA (US)

(21) Appl. No.: 13/466,362

(22) Filed: May 8, 2012

(51) Int. Cl. G06Q 50/22

(52) U.S. Cl. 705/2

(57) ABSTRACT

A medication ordering system comprises at least one repository including information identifying candidate medication orders and associated related order parameters including dosage and route of administration. An order processor, in response to user entry of text, compiles a list of medication orders, by, searching the information to identify order data items representing medication orders including matching text and by collating the identified order items to provide a compiled list. The compiled list having itemized hierarchical priority of, (1) orders most frequently placed by the user for a patient with a particular hospital admission department, (2) orders most frequently placed by multiple different users of the ordering system and (3) other orders placed by users of the ordering system. A display processor initiates generation of a display image enabling a user to select orders from the compiled list.

### FIELD OF THE INVENTION

The present invention concerns a medication ordering system, involving compiling a list of medication orders, by finding and collating order items to provide a compiled list with itemized hierarchical priority.

### BACKGROUND OF THE INVENTION

A physician spends substantial patient time using computerized physician order entry search functions to identify orders for medications to be administered to a patient, for example. Working in a particular domain, a physician tends to utilize a small number of unique treatment and medication orders rather than a large set of the treatment orders available. Known ordering systems typically do not provide a medication recommendation and fail to utilize user and system preferences and history. A system according to invention principles addresses these deficiencies and related problems.

### SUMMARY OF THE INVENTION

An order entry system provides a compiled list of medications concurrently with a user entering order text, in response to patient location and age and the most frequently historically placed orders by the user and other users of the system excluding duplicate medications and identifying allergies and medication interactions. A medication ordering system comprises at least one repository including information identifying candidate medication orders and associated related order parameters including dosage and route of administration. An order processor, in response to user entry of text, compiles a list of medication orders for a patient, by, searching the information to identify order data items representing medication orders including matching text and by collating the identified order items to provide a compiled list. The compiled list has itemized hierarchical priority of, (1) orders most frequently placed by the user for patients (2) orders placed by users of the ordering system associated with a hospital admission department of said patient. A display processor initiates generation of display elements enabling a user to select orders from the compiled list.

### BRIEF DESCRIPTION OF THE DRAWINGS

FIG. 1 shows a medication ordering system, in accordance with invention principles.

FIG. 2 shows a list of medication orders ranked based on, orders most frequently placed by a user, multiple different users and other orders placed by users of an ordering system, in accordance with invention principles.

FIG. 3 is a diagram showing system orders and sets of orders most frequently placed by a user and multiple different users.

FIGS. 4, 5 and 6 show Tables listing all medication orders in a system, most frequently placed orders by a user and most frequently placed orders by multiple different users, respectively, in accordance with invention principles.

FIG. 7 shows a Table listing all medication orders in a system, in accordance with invention principles.

FIG. 8 shows a Table listing medication orders in a system identified in response to user entered search text, in accordance with invention principles.

FIGS. 9 and 10 show Tables listing duplicate medications and medication orders having interactions, in accordance with invention principles.

FIG. 11 shows a Table identifying a medication potentially having an allergic response for a patient in a list of medication orders, in accordance with invention principles.

FIG. 12 shows a list of medications compiled by the system in response to medication orders present in an ordering cart and in response to a search, in accordance with invention principles.

FIG. 13 shows a list of medications compiled by the system in response to medication orders provided to patients at discharge matching a current medication order for a patient, in accordance with invention principles.

FIGS. 14A and FIG. 14B show a flowchart of a process performed by a medication ordering system in compiling a medication list, in accordance with invention principles.

FIG. 15 shows a flowchart of a process performed by a medication ordering system, in accordance with invention principles.

### DETAILED DESCRIPTION OF THE INVENTION

A system uses an automatic medication search to provide candidate medication auto-suggestion to a physician during computerized physician medication order entry. The candidate medication suggestions are derived in response to a search based on entered text using a combination of user past ordering history and the most frequently used orders in the system. In addition, search results presented in a compiled medication list indicates whether a medication order is a duplicate, the order has conflicts with others or the patient is allergic to the order. Candidate suggestions also take into account patient location and are derived from orders including orders placed for other patients who are discharged and orders for their home medications.

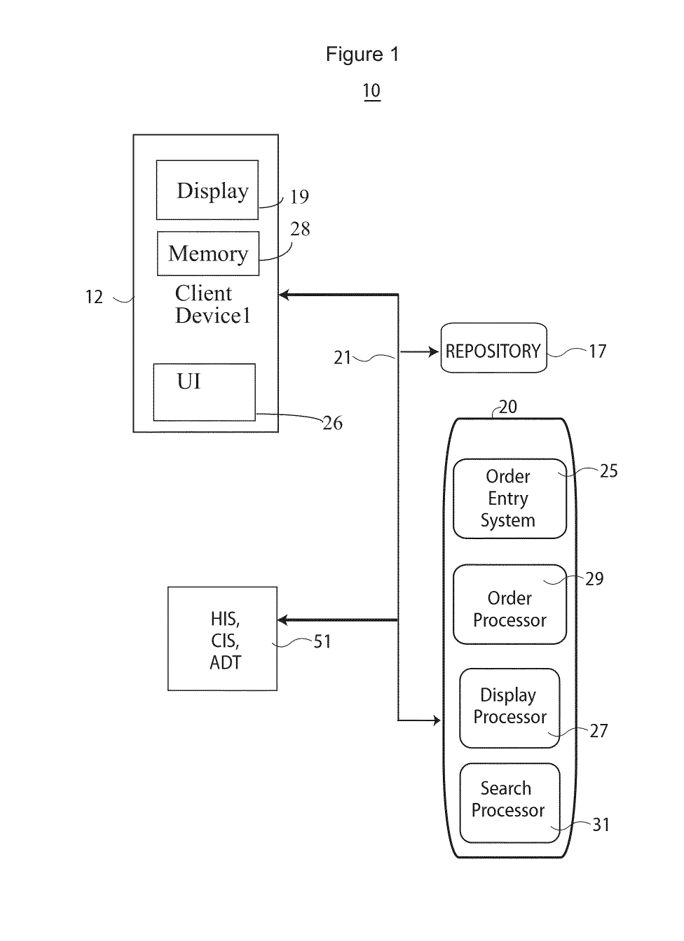

FIG. 1 shows medication ordering system 10 including one or more processing devices on network 21 (e.g., workstations, computers or portable devices such as notebooks, Personal Digital Assistants, phones) 12 that individually include a user interface 26 enabling user interaction with a Graphical User Interface (GUI) and display 19 supporting GUI and medical data, image and administrative information presentation in response to predetermined user (e.g., physician, nurse administrator) specific preferences. System 10 also includes at least one repository 17, server 20 and HIS 51 (including ADT, clinical information and other applications) intercommunicating via network 21. Server 20 includes order processor 29, display processor 27, search processor 31 and order entry system 25.

At least one repository 17 includes information identifying candidate medication orders and associated related order parameters including dosage and route of administration. Order processor 29, in response to user entry of text, compiles a list of medication orders, by using search processor 31 in searching the information to identify order data items representing medication orders including matching text and by collating the identified order items to provide a compiled list with itemized hierarchical priority. The hierarchical priority comprises, (1) orders most frequently placed by the user for a patient with a particular hospital admission department, (2) orders most frequently placed by multiple different users of the ordering system and (3) other orders placed by users of the ordering system. Display processor 27 initiates generation of display elements enabling a user to select orders from the compiled list.

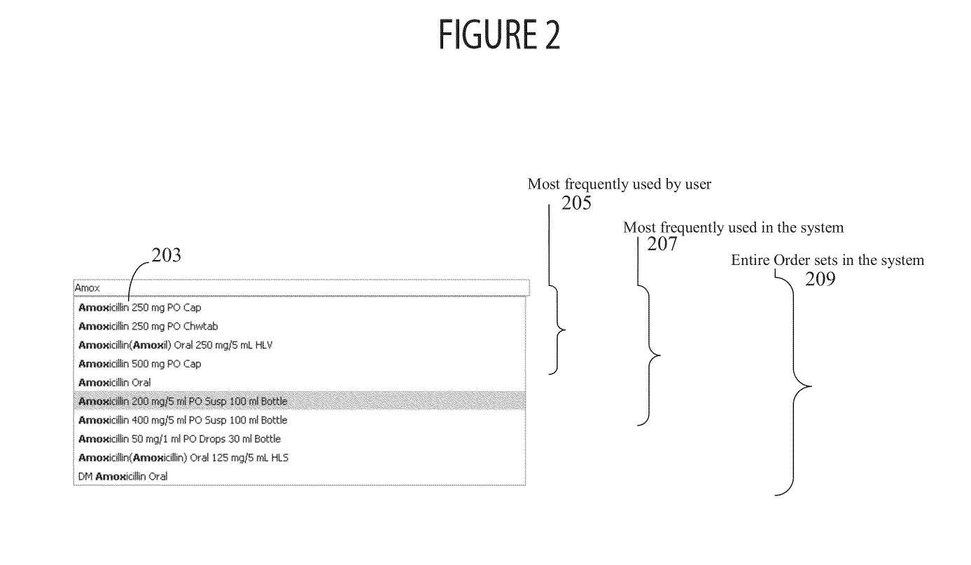

FIG. 2 shows list of medication orders 203 ranked based on, orders most frequently placed by a user 205, orders most frequently placed by multiple different users 207 and other orders 209 placed by users of an ordering system. The other orders 209 encompass orders most frequently placed by multiple different users 207 which in turn encompass orders most frequently placed by an individual user 205. An order holds information about its creator, and the system creates a pattern (cumulative counts of individual medication orders over a predetermined time period) by examining and monitoring orders placed by an individual user (and multiple users as well as system wide) in a predetermined time period (e.g. week, month year). In one embodiment the system performs a nightly batch job execution, for example, that gathers information about user specific most frequently used orders (service counts) and populates the information in a database in association with data indicating medication usage for pediatric or adult patients. When a physician is placing orders for a particular patient, the system uses patient age to determine whether pediatric or adult orders are to be displayed to a user. Repository 17 stores the gathered information and data indicating available orders in the system.

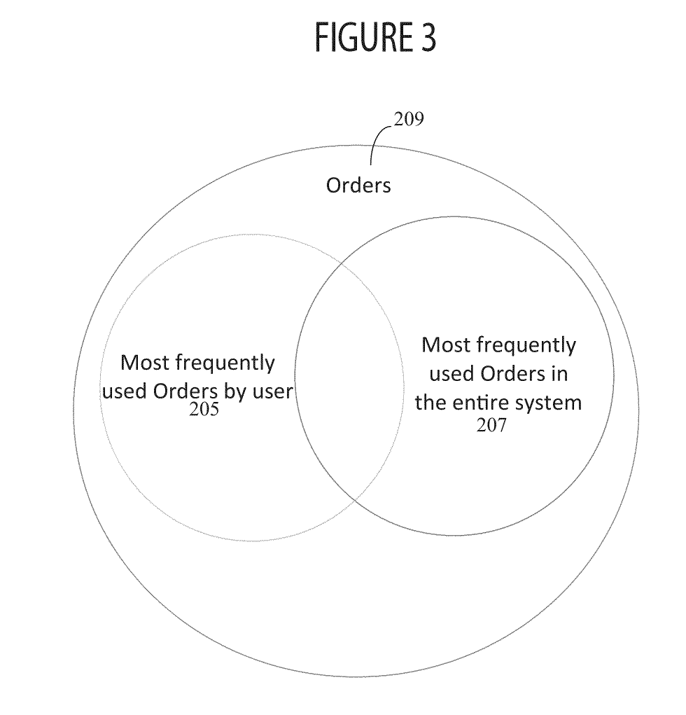

FIG. 3 is a diagram showing system orders 209 and sets of orders most frequently placed by a user 205 and multiple different users 207. A suggested candidate medication list in one embodiment, includes a combination of most frequently used orders by the user 205, most frequently used order by the system (multiple users) 207 and other possible orders 209 derived from a comprehensive orders list up to a predetermined display limit.

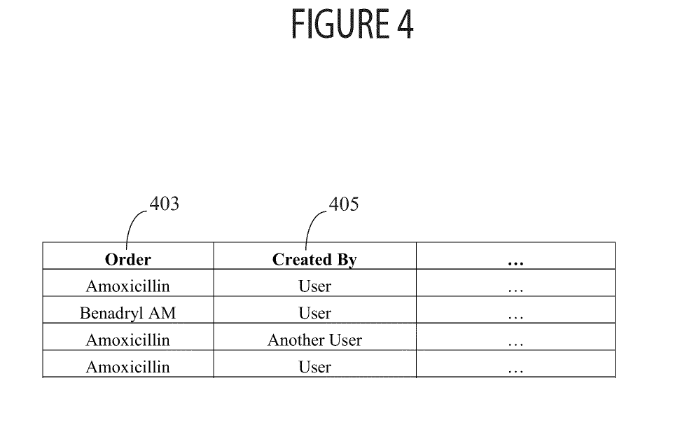

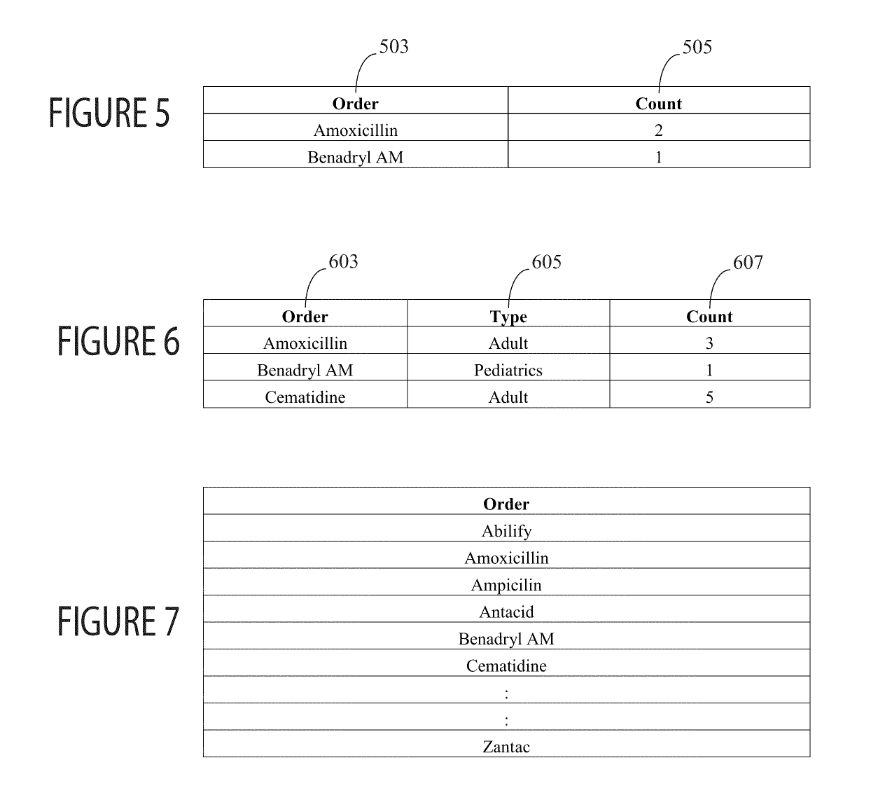

FIGS. 4, 5 and 6 show Tables stored in repository 17 (FIG. 1) listing all medication orders in a system, most frequently placed orders by a user and most frequently placed orders by multiple different users, respectively. FIG. 4 shows orders in column 403 and identifies a corresponding user who placed the orders in column 405. FIG. 5 shows orders most frequently placed by a particular user in column 503 and corresponding number of times individual orders are placed during a predetermined time period in column 505. FIG. 6 shows orders placed by multiple different users in a system in column 603 and corresponding number of times individual orders are placed during a predetermined time period in column 607 and identifies whether an individual order is an adult or pediatric order in column 605.

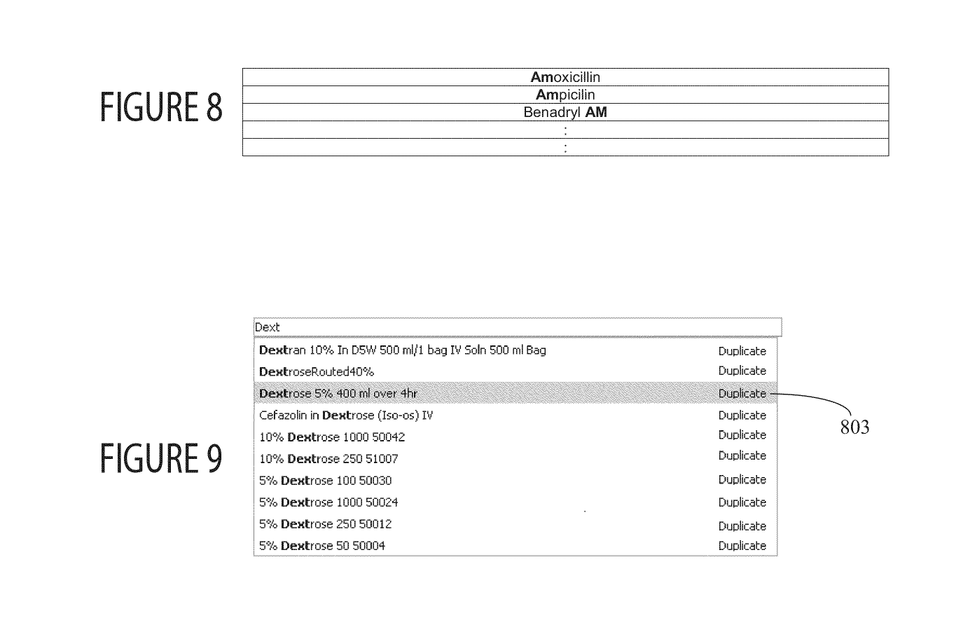

FIG. 7 shows a Table stored in repository 17 listing the available medication orders in a system. In response to a user entered search term keyword, search processor 31 performs a candidate medication search and provides a list of medication order representative words which start with the user entered keyword. e.g. if a user enters text “Am” then Amoxicillin and Benadryl AM show up in the list, for example, but Dexamethasone does not, as shown in the search result candidate medication orders of the Table of FIG. 8. In response to a user entering text “Am” in a picklist search box, search processor 31 populates a suggested candidate medication list as shown in FIG. 8 based on a user ordering pattern of the particular user concerned and searches for a system wide pattern and other orders in the system until a predetermined limit is reached.

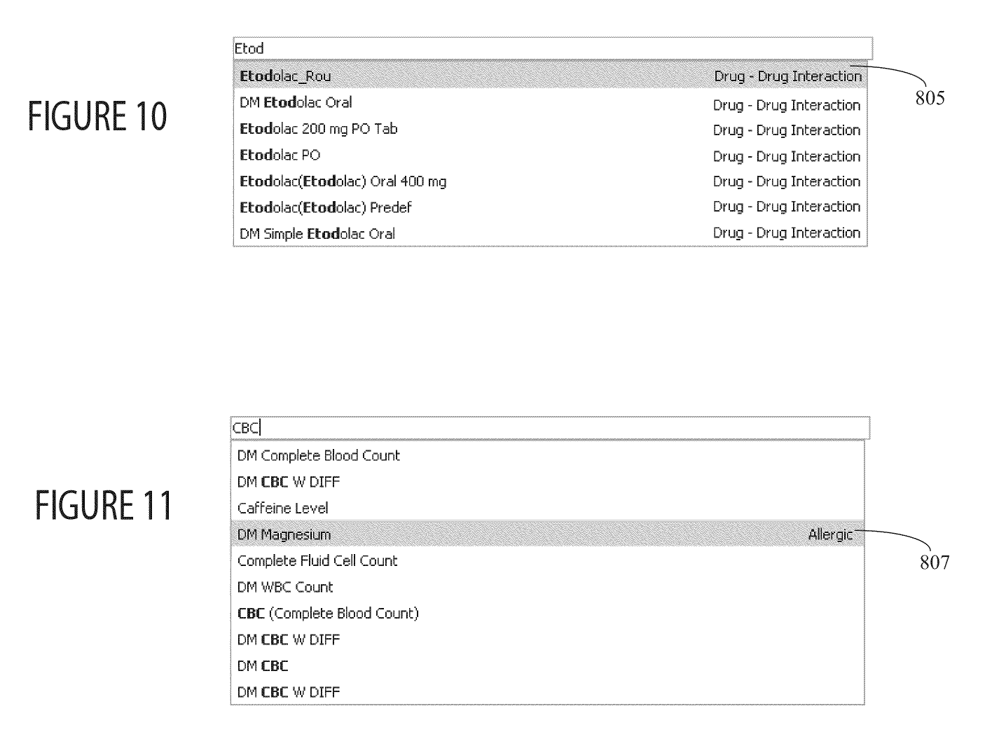

FIGS. 9 and 10 show Tables listing duplicate medications and medication orders having interactions. Order processor 29 checks in real-time whether there are potential duplicate orders (e.g. order 803) already existing for a particular patient for medications on a compiled medication list. Further processor 29 identifies and removes duplicates medication orders from an ordering cart (COS).

Processor 29 also checks in real-time whether there is a potential drug-drug interaction (e.g. order 805) with already existing orders of a particular patient and with orders for the particular patient in the ordering cart (COS), for medications on a compiled medication list. FIG. 11 shows a Table identifying a medication potentially having an allergic response for a patient in a list of medication orders. Order processor 29 checks in real-time whether a patient is allergic to a medication order (e.g. order 807) on a compiled medication list based on the allergies documented for the patient in a patient medical record.

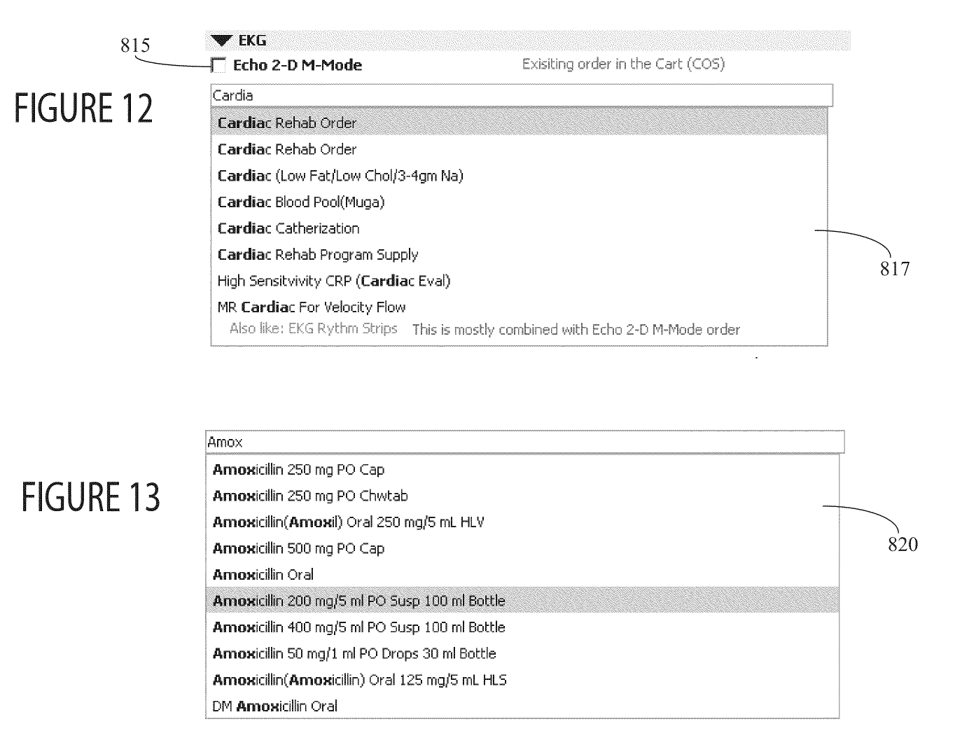

FIG. 12 shows a list of medications compiled by the system in response to medication orders present in an ordering cart and in response to a user initiated search in an ordering sessions. Order processor 29 identifies orders in an ordering cart e.g. order 815 for an ultrasound echocardiogram and search processor 31 automatically populates suggested candidate medication list 817 as shown with orders medically associated with orders in the cart. A user also may initiate a search using processor 31 for suggested candidate medication orders with medically plausible combinations with the existing order 815 in the COS by entry of a search term.

FIG. 13 shows a list of medications 820 compiled by the system in response to medication orders provided to patients at discharge as well as medications for use at home following discharge. Order processor 29 and processor 31 search to identify medication orders placed for patients who are discharged and given to take home and these medications are assumed to be valid and effective. Order processor 29 creates a model comprising a set of orders and medications including the identified medication orders placed for patients at discharge and as home medications together with current inpatient medications. The set of medications is used for deriving suggested candidate medications in response to a search performed by processor 31 upon entry of text in a search box.

The system identifies a specialty unit (e.g. infectious disease unit) or other admission department of a patient and determines it is likely that the patient is being admitted for a particular reason related to the admission department. The system provides a suggested candidate medication in response to the location information of a patient to provide more intelligent suggestions, e.g. if a patient is admitted to an infectious disease unit the system provides a suggested candidate medication list including medications to treat infectious disease.

In one embodiment, in response to a user initiated search and entry of a search term, the system instead of showing multiple medication orders having matching full or partial text, prompts a user with selectable different text terms comprising different associated search terms to provide a user with more search options. The system employs prioritized search rules resolving competing factors, e.g. if a search indicates a user has no previous orders for a patient of the patient age e.g. a child but there are orders from multiple different users for a child, the system selects the orders from the different users. Similarly, if there are system orders for a patient having a particular appropriate admission department but the ordering user has no such orders but does have an order for the appropriate aged patient, the ordering users orders for the appropriate aged patient have higher priority. Further, if there is no ordering history for a user, candidate medication suggestions comprise system wide most frequently placed orders. As user history grows the results are refined.

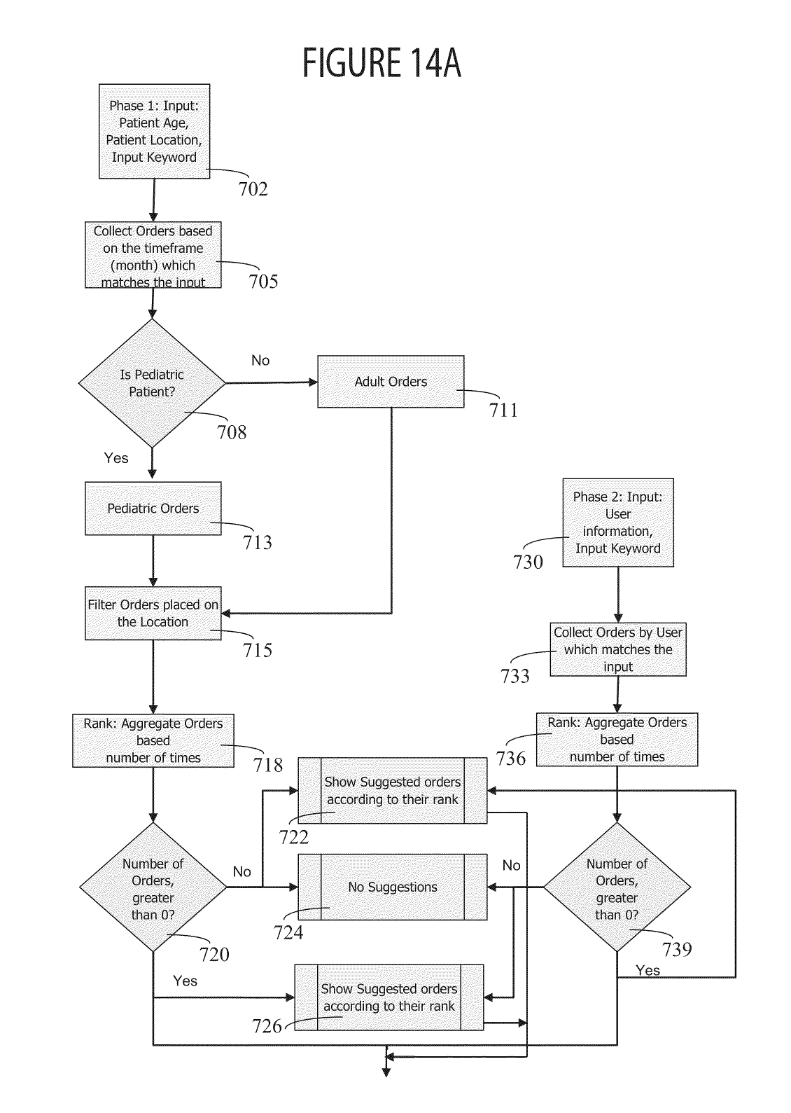

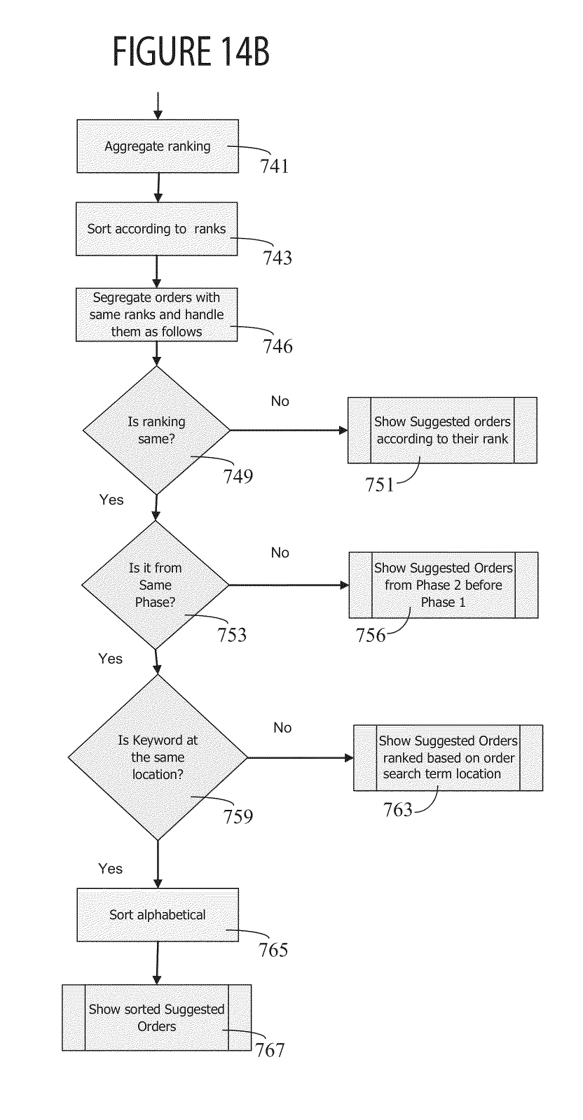

FIGS. 14A and FIG. 14B show a flowchart of a process performed by medication ordering system 10 (FIG. 1) in compiling a medication list. In step 705, order processor 29 acquires data representing system wide popular orders (phase 1 orders) based on patient age and location (e.g. admission department) for a particular time frame (e.g. month, year) in response to user identification data and user entered search term text (keyword), received in step 702. In response to determining the patient is a child in step 708, processor 29 parses the acquired orders to identify pediatric orders associated with patient location (admission department) in steps 713 and 715. In response to determining the patient is an adult in step 708, processor 29 parses the acquired orders to identify adult orders associated with patient location (admission department) in steps 711 and 715. Processor 29 in step 718 sorts, prioritizes and ranks most frequently placed orders identified in step 715 in response to age and location and provides the ranked orders to step 720.

Processor 29 in step 733 also acquires data representing most frequently placed orders (phase 2 orders) for a logged in ordering user in response to user identification data and entry of a search term in step 730. Processor 29 in step 736 sorts, prioritizes and ranks the user most frequently placed orders identified in step 736 in response to, age and patient admission location (e.g. department) and provides the ranked orders to step 739. If no system wide or user specific frequently placed orders are identified as determined in steps 720 and 739, no candidate medications are suggested and the process terminates at step 724. If it is determined in step 720 that system wide orders are identified but in step 739 no user specific frequently placed orders are identified, processor 29 in step 726 prioritizes and ranks the orders identified in step 720 with the higher the frequency of placement of an order, the higher the rank. If it is determined in step 722 that there are no system wide orders identified but in step 739 user specific frequently placed orders are identified, processor 29 in step 726 prioritizes and ranks the orders identified in step 739 with the higher the frequency of placement of an order, the higher the rank.

If system wide and user specific frequently placed orders are identified in at least one of steps 720 and 739, the orders are aggregated in step 741 and sorted in step 743. Processor 29 combines ranking of most frequently placed user and system wide orders summing the frequency of use of phase 1 and 2 orders and sorts them accordingly. The orders are segregated in step 746 to group order with the same rank. If it is determined in step 749 that the grouped orders do not have the same rank, the grouped orders are output and displayed as a candidate compiled medication list in step 751. If it is determined in step 749 that the grouped orders have the same rank and in step 753 it is determined the grouped orders are not exclusively system wide frequently placed orders and are not exclusively user specific frequently placed orders, the grouped orders are output and displayed as a candidate compiled medication list in step 756. If it is determined in step 749 that the grouped orders have the same rank and in step 753 are exclusively system wide frequently placed orders or are exclusively user specific frequently placed orders and in step 759 it is determined the grouped orders have a search term at different locations relative to start of the order text strings, the grouped orders are output and displayed as a sorted candidate compiled medication list in step 763. Specifically, in step 763 the candidate compiled medication list is sorted to provide medication orders ranked so that the nearer a search term (keyword(s)) appears to the beginning of an order text string, the higher the ranking and priority in which the medication order is displayed.

In step 759, if it is determined the grouped orders have a search term at the same locations relative to start of the order text strings, the grouped orders are sorted alphabetically in step 765 and output and displayed as a sorted candidate compiled medication list in step 767.

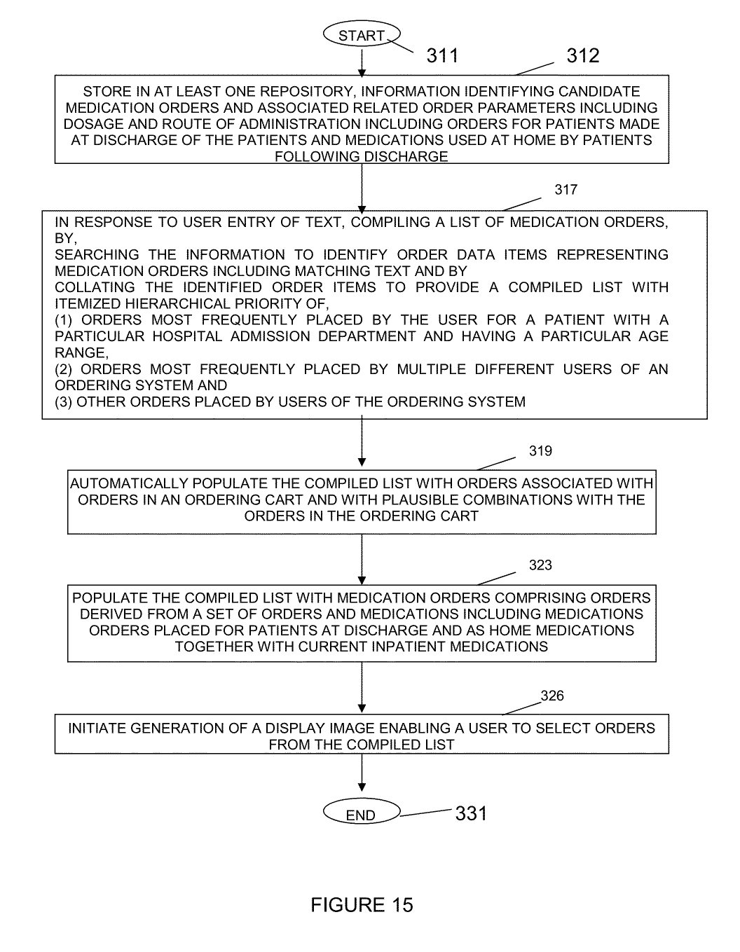

FIG. 15 shows a flowchart of a process performed by a medication ordering system 10 (FIG. 1). In step 312 following the start at step 311, order processor 29 stores information in at least one repository 17. The information identifies candidate medication orders and associated related order parameters including dosage and route of administration including orders for patients made at discharge of the patients, medications used at home by patients following discharge, orders currently place for patients and medications previously placed for patients. The associated related order parameters identify, (a) quantity, (b) a route of administration of a medical treatment, (c) a frequency of administering a treatment and (d) a form of medical treatment comprising at least one of, (i) a package type, (ii) a strength of a medical treatment and (iii) a concentration of a medical treatment.

In step 317, order processor 29, in response to user entry of text, compiles a list of medication orders. Search processor 31 searches the information to identify order data items representing medication orders including matching text. Processor 29 collates the identified order items to provide a compiled list for a patient with itemized hierarchical priority of, (1) orders most frequently placed by the user for patients, (2) orders placed by users of the ordering system associated with a hospital admission department of said patient and an age range of said patient. In one embodiment, the orders most frequently placed by multiple different users of the ordering system comprise orders most frequently placed by multiple different users of the ordering system for patients with the particular hospital admission department. In an embodiment, the other orders placed by users of the ordering system comprise other orders placed by users of the ordering system for patients with the particular hospital admission department. In one embodiment, the orders most frequently placed by the user for the patient with the particular hospital admission department comprise orders most frequently placed by the user for patients with the particular hospital admission department and having a particular age range.

In step 319, order processor 29 identifies orders in an ordering cart and automatically populates the compiled list with data representing orders associated with orders in the cart and with data representing medication orders comprising medically plausible combinations with the orders in the ordering cart. Order processor 29 in step 323 generates data representing a set of orders and medications including medication orders placed for patients at discharge and as home medications together with current inpatient medications and populates the compiled list with data representing medication orders comprising orders from the set. The order processor identifies a duplicate order for a medication currently prescribed for the patient and also present on the compiled list and also duplicate order items within the compiled list and removes duplicate orders from the compiled list. The order processor identifies an order for a medication associated with an allergy of the patient and indicates a medication may trigger an allergy with a warning message in a displayed order list. The order processor identifies an order for a medication having a potential interaction with a medication currently prescribed for the patient and identifies orders for medications on the compiled list having a potential interaction and indicates interactions with a warning message in a displayed order list. In step 326 display processor 27 initiates generation of a display image enabling a user to select orders from the compiled list comprising a scrollable list of a predetermined number of orders. The process of FIG. 15 terminates at step 331.

The frequency of placing orders comprises the number of times that an order is placed within a predetermined time period by an entity (e.g. a physician, a hospital, hospital system or hospital department). A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. Computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s). A user interface processor or generator is a known element comprising electronic circuitry or software or a combination of both for generating display elements or portions thereof. A user interface comprises one or more display elements enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display elements, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the elements for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display elements in response to signals received from the input devices. In this way, the user interacts with the display elements using the input devices, enabling user interaction with the processor or other device. The functions and process steps herein may be performed automatically or wholly or partially in response to user command An activity (including a step) performed automatically is performed in response to executable instruction or device operation without user direct initiation of the activity.

The system and processes of FIGS. 1-15 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system collates order items to provide a compiled list with itemized hierarchical priority of orders most frequently placed by the user or multiple users, for a patient with a particular hospital admission department and having a particular age range and automatically populates the compiled list with data representing orders associated with orders in an ordering cart and with data representing medication orders comprising medically plausible combinations with the orders in the ordering cart. Further, the processes and applications may, in alternative embodiments, be located on one or more (e.g., distributed) processing devices on a network linking the units FIG. 1. Any of the functions and steps provided in FIGS. 1-15 may be implemented in hardware, software or a combination of both. No claim element herein is to be construed under the provisions of 35 U.S.C. 112, sixth paragraph, unless the element is expressly recited using the phrase “means for.”

What is claimed is:

1. A medication ordering system, comprising:
at least one repository including information identifying candidate medication orders and associated related order parameters including dosage and route of administration; and
an order processor for, in response to user entry of text, compiling a list of medication orders for a patient, by,
searching said information to identify order data items representing medication orders including matching text and by
collating the identified order items to provide a compiled list with itemized hierarchical priority of,
(1) orders most frequently placed by said user for patients,
(2) other orders placed by users of said ordering system associated with a hospital admission department of said patient; and
a display processor for initiating generation of a display image enabling a user to select orders from said compiled list.

2. A system according to claim 1, wherein
said information identifies candidate medication orders including,
orders for patients made at discharge of the patients and
medications used at home by patients following discharge.

3. A system according to claim 2, wherein
said information identifies candidate medication orders including,
orders currently place for patients and
medications previously placed for patients.

4. A system according to claim 1, wherein
said order processor collates the identified order items to provide a compiled list with itemized hierarchical priority of,
(1) orders most frequently placed by said user for patients,
(2) other orders placed by users of said ordering system associated with a hospital admission department of said patient and
(3) orders most frequently placed by multiple different users of said ordering system

5. A system according to claim 1, wherein
said orders most frequently placed by multiple different users of said ordering system comprise orders most frequently placed by multiple different users of said ordering system for patients with said particular hospital admission department.

6. A system according to claim 1, wherein
said other orders placed by users of said ordering system comprise other orders placed by users of said ordering system for patients with said particular hospital admission department.

7. A system according to claim 1, wherein
said orders most frequently placed by said user for said patient with said particular hospital admission department comprise orders most frequently placed by said user for patients with said particular hospital admission department and having a particular age range.

8. A system according to claim 1, wherein
said compiled list is a scrollable list of a predetermined number of orders

9. A system according to claim 1, wherein
said order processor identifies a duplicate order for a medication currently prescribed for said patient and also present on the compiled list and also duplicate order items within said compiled list and removes duplicate orders from said compiled list.

10. A system according to claim 1, wherein
said order processor identifies an order for a medication associated with an allergy of said patient and indicates a medication may trigger an allergy with a warning message in a displayed order list.

11. A system according to claim 1, wherein
said order processor identifies an order for a medication having a potential interaction with a medication currently prescribed for said patient and identifies orders for medications on said compiled list having a potential interaction and indicates interactions with a warning message in a displayed order list.

12. A system according to claim 1, wherein
said associated related order parameters identify, (a) quantity, (b) a route of administration of a medical treatment, (c) a frequency of administering a treatment and (d) a form of medical treatment comprising at least one of, (i) a package type, (ii) a strength of a medical treatment and (iii) a concentration of a medical treatment.

13. A system according to claim 1, wherein
said order processor identifies orders in an ordering cart and automatically populates the compiled list with data representing orders associated with orders in the cart.

14. A system according to claim 13, wherein
said order processor populates the compiled list with data representing medication orders comprising plausible combinations with said orders in said ordering cart.

15. A system according to claim 1, wherein
said order processor,
generates data representing a set of orders and medications including medication orders placed for patients at discharge and as home medications together with current inpatient medications and
populates the compiled list with data representing medication orders comprising orders from said set.

16. A medication ordering system, comprising:
at least one repository including information identifying candidate medication orders and associated related order parameters including dosage and route of administration including orders for patients made at discharge of the patients and medications used at home by patients following discharge; and
an order processor for, in response to user entry of text, compiling a list of medication orders for a patient, by,
searching said information to identify order data items representing medication orders including matching text and by
collating the identified order items to provide a compiled list with itemized hierarchical priority of,
(1) orders most frequently placed by said user for a patient with a particular hospital admission department and having a particular age range,
(2) orders placed by users of said ordering system associated with a hospital admission department of said patient; and
a display processor for initiating generation of a display image enabling a user to select orders from said compiled list.

17. A method for medication ordering, comprising the activities of:
storing information identifying candidate medication orders and associated related order parameters including dosage and route of administration; and
in response to user entry of text, compiling a list of medication orders for a patient, by,
searching said information to identify order data items representing medication orders including matching text and by
collating the identified order items to provide a compiled list with itemized hierarchical priority of,
(1) orders most frequently placed by said user for a patient with a particular hospital admission department,
(2) orders placed by users of said ordering system associated with said hospital admission department of said patient; and
initiating generation of a display image enabling a user to select orders from said compiled list.

18. A method according to claim 17, wherein
said information identifies candidate medication orders including,
orders for patients made at discharge of the patients and
medications used at home by patients following discharge.

19. A method according to claim 17, wherein
said information identifies candidate medication orders including,
orders currently place for patients and
medications previously placed for patients.

20. A method according to claim 17, including the activities of
collating the identified order items to provide a compiled list with itemized hierarchical priority of,
(1) orders most frequently placed by said user for a patient with said hospital admission department,
(2) orders placed by users of said ordering system associated with said hospital admission department of said patient and
(3) orders associated with said particular hospital admission department and most frequently placed by multiple different users of said ordering system.

21. A method according to claim 17, wherein
said orders most frequently placed by said user for said patient with said particular hospital admission department comprise orders most frequently placed by said user for patients with said particular hospital admission department and having a particular age range.

22. A method according to claim 17, wherein
said associated related order parameters identify, (a) quantity, (b) a route of administration of a medical treatment, (c) a frequency of administering a treatment and (d) a form of medical treatment comprising at least one of, (i) a package type, (ii) a strength of a medical treatment and (iii) a concentration of a medical treatment.

23. A method according to claim 17, including the activity of
identifying orders in an ordering cart and automatically populating the compiled list with orders associated with orders in the cart.

24. A method according to claim 23, including the activity of
populating the compiled list with data representing medication orders comprising plausible combinations with said orders in the cart.

25. A method according to claim 17, including the activities of
generating data representing a set of orders and medications including medication orders placed for patients at discharge and as home medications together with current inpatient medications and
populating the compiled list with medication orders comprising orders from said set.
